(19) United States
(12) Patent Application Publication
(10) Pub. No.: US 2016/0050377 A1
(43) Pub. Date: Feb. 18, 2016

(54) ACTIVE PIXEL SENSORS AND IMAGE DEVICES HAVING STACKED PIXEL STRUCTURE SUPPORTING GLOBAL SHUTTER

(71) Applicant: Samsung Electronics Co., Ltd., Suwon-si (KR)

(72) Inventors: Uzi HIZI, Ramat Gan (IL); Mickey BAHAR, Ramat Gan (IL); Yoel YAFFE, Ramat Gan (IL)

(73) Assignee: SAMSUNG ELECTRONICS CO., LTD., Suwon-Si, Gyeonggi-Do (KR)

(21) Appl. No.: 14/457,490

(22) Filed: Aug. 12, 2014

(51) Int. Cl. H04N 5/369; H04N 5/374; H04N 5/353

(52) U.S. Cl. CPC H04N 5/3696; H04N 5/3532; H04N 5/3742

(57) ABSTRACT

A global shutter pixel has a stacked pixel structure. The pixel includes a sample and readout circuit on a lower substrate and a photodiode and transfer circuit on an upper substrate. The sample and readout circuit is configured to store accumulated charge and output a pixel data signal corresponding to the stored accumulated charge. The photodiode and transfer circuit is configured to accumulate charge in response to incident light, and to transfer the accumulated charge to the sample and readout circuit, the upper substrate being stacked on the lower substrate.

### BACKGROUND

In complementary-metal-oxide-semiconductor (CMOS) image sensors operating with electronic rolling shutter, artifacts may be observed in an image of a captured scene when the captured scene includes objects moving relatively fast. This is due to the different exposure times of different pixels of the image sensor. To address this issue, a global shutter may be used. In a conventional image sensor using global shutter, the exposure times of all pixels in the image sensor array completely overlap.

In larger sensor arrays, all pixels cannot be read out at the same time. As a result, pixel readout is performed in a rolling fashion. In this scenario, an in-pixel capacitor may be used to store pixel data (e.g., charge or voltage) within the pixel from the time that the exposure of the pixel ends (for the entire array, simultaneously) until the pixel readout (at different times for different pixels).

### SUMMARY

One or more example embodiments provide active pixel sensor (APS) arrays for complementary-metal-oxide-semiconductor (CMOS) image sensors. According to at least some example embodiments, an APS array utilizes stacked sensor technology to achieve global shutter operation by transferring charge from a pinned photodiode structure in a top chip (or substrate) to a pixel capacitor on a bottom chip (or substrate) of a given pixel, and employing a standard four transistor (4T) readout from the bottom chip circuitry. The charge transfer via can be shared among several pixels of an APS array.

According to at least some example embodiments, image sampling may be performed by charge transfer and without biasing and/or double sampling.

At least one example embodiment provides a global shutter pixel having a stacked pixel structure, the pixel including: a sample and readout circuit on a lower substrate, the sample and readout circuit being configured to store accumulated charge and output a pixel data signal corresponding to the stored accumulated charge; and a photodiode and transfer circuit on an upper substrate, the photodiode and transfer circuit being configured to accumulate charge in response to incident light, and to transfer the accumulated charge to the sample and readout circuit, the upper substrate being stacked on the lower substrate.

The sample and readout circuit may be electrically connected to the photodiode and transfer circuit by a via between the upper substrate and the lower substrate.

The global shutter pixel may further include: a control switch between the via and the sample and readout circuit on the lower substrate, the control switch being configured to electrically disconnect the photodiode and transfer circuit from the sample and readout circuit during readout of the pixel data signal from the sample and readout circuit.

The photodiode and transfer circuit may be configured to transfer the accumulated charge directly to the sample and readout circuit without being stored on the upper substrate.

The sample and readout circuit may include: a pixel capacitor configured to store the accumulated charge; a sample and hold transistor coupled to the pixel capacitor, the sample and hold transistor being configured to readout the stored accumulated charge from the pixel capacitor in response to a sampling pulse; and a readout circuit configured to output the pixel data signal corresponding to the accumulated charge in response to a select pulse.

The readout circuit may include: a source-follower transistor configured to generate the pixel data signal based on the stored accumulated charge readout by the sample and hold transistor; and a select transistor configured to output the pixel data signal in response to the select pulse.

At least one other example embodiment provides an active pixel sensor including: a plurality of unit pixels, each of the plurality of unit pixels including a plurality of subpixels. Each of the plurality of subpixels includes: a sample and readout circuit on a lower substrate, the sample and readout circuit being configured to store accumulated charge, and to output a pixel data signal corresponding to the stored accumulated charge; and a photodiode and transfer circuit on an upper substrate, the upper substrate being stacked on the lower substrate, and the photodiode and transfer circuit being configured to accumulate charge in response to incident light, and to transfer the accumulated charge to the sample and readout circuit.

Each of the plurality of subpixels may share a common via, the photodiode and transfer circuit may be electrically connected to the sample and readout circuit by the common via.

The active pixel sensor may further include: a plurality of control switches, each of the plurality of control switches being between the common via and a corresponding sample and readout circuit on the lower substrate, and each of the plurality of control switches being configured to electrically disconnect the photodiode and transfer circuit from a corresponding sample and readout circuit during readout of the pixel data signal from the corresponding sample and readout circuit.

The photodiode and transfer circuit may be configured to transfer the accumulated charge directly to the sample and readout circuit without being stored on the upper substrate.

The sample and readout circuit may include: a pixel capacitor configured to store the accumulated charge; a sample and hold transistor coupled to the pixel capacitor, the sample and hold transistor being configured to readout the stored accumulated charge from the pixel capacitor in response to a sampling pulse; and a readout circuit configured to output the pixel data signal corresponding to the accumulated charge in response to a select pulse.

The readout circuit may include: a source-follower transistor configured to generate the pixel data signal based on the stored accumulated charge readout by the sample and hold transistor; and a selection transistor configured to output the pixel data signal in response to the select pulse.

At least one other example embodiment provides an image sensor including: an active pixel sensor including a plurality of unit pixels, each of the plurality of unit pixels including a plurality of subpixels; a line driver configured to control the active pixel sensor; and an analog-to-digital converter configured to convert pixel data signals output from the active pixel sensor into digital image data. Each of the plurality of subpixels includes: a sample and readout circuit on a lower substrate, the sample and readout circuit being configured to store accumulated charge, and to output a pixel data signal corresponding to the stored accumulated charge; and a photodiode and transfer circuit on an upper substrate, the upper substrate being stacked on the lower substrate, and the photodiode and transfer circuit being configured to accumulate charge in response to incident light, and to transfer the accumulated charge to the sample and readout circuit.

Each of the plurality of subpixels may share a common via, and the photodiode and transfer circuit may be electrically connected to the sample and readout circuit by the common via.

The active pixel sensor may further include: a plurality of control switches, each of the plurality of control switches being between the common via and a corresponding sample and readout circuit on the lower substrate, and each of the plurality of control switches being configured to electrically disconnect the photodiode and transfer circuit from a corresponding sample and readout circuit during readout of the pixel data signal from the corresponding sample and readout circuit.

The photodiode and transfer circuit may be configured to transfer the accumulated charge directly to the sample and readout circuit without being stored on the upper substrate.

The sample and readout circuit may include: a pixel capacitor configured to store the accumulated charge; a sample and hold transistor coupled to the pixel capacitor, the sample and hold transistor being configured to readout the stored accumulated charge from the pixel capacitor in response to a sampling pulse; and a readout circuit configured to output the pixel data signal corresponding to the accumulated charge in response to a select pulse.

The readout circuit may include: a source-follower transistor configured to generate the pixel data signal based on the stored accumulated charge readout by the sample and hold transistor; and a select transistor configured to output the pixel data signal in response to the select pulse.

At least one other example embodiment provides a method of operating an active pixel sensor including global shutter pixels having a stacked pixel structure, the method including: accumulating, at a photodiode and transfer circuit on an upper substrate, charge in response to incident light; transferring the accumulated charge from the photodiode and transfer circuit on the upper substrate to a sample and readout circuit on a lower substrate, the upper substrate being stacked on the lower substrate; storing the accumulated charge at the sample and readout circuit on the lower substrate; and outputting, by the sample and readout circuit on the lower substrate, a pixel data signal corresponding to the stored accumulated charge.

The transferring may transfer the accumulated charge directly from the photodiode and transfer circuit to the sample and readout circuit without being stored on the upper substrate.

### BRIEF DESCRIPTION OF THE DRAWINGS

Example embodiments will become more appreciable through the description of the drawings in which:

FIG. 1 is a block diagram illustrating an example embodiment of an image sensor.

FIG. 2A illustrates a portion of an upper chip of the active pixel sensor (APS) array 100 shown in FIG. 1.

FIG. 2B illustrates a portion of a lower chip of the APS array 100 shown in FIG. 1.

FIG. 3A is a circuit diagram illustrating a portion of a pixel circuit on the upper chip shown in FIG. 2A, according to an example embodiment.

FIG. 3B is a more detailed circuit diagram of a portion of a pixel circuit for a group of pixels 200 shown in FIG. 3A, according to an example embodiment.

FIG. 4A is a circuit diagram illustrating a portion of a pixel circuit on the lower chip shown in FIG. 2B, according to an example embodiment.

FIG. 4B is a more detailed circuit diagram of a portion of a pixel circuit for a group of pixels shown in FIG. 4A.

FIG. 5 illustrates an alternative structure of a sample and readout circuit portion on a lower chip of the APS array 100, according to an example embodiment.

FIGS. 6 and 7 are timing diagrams for illustrating example operation of the APS array 100.

FIG. 8 is a block diagram illustrating an example embodiment of an electronic system.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc., may be passed, forwarded, or transmitted via any suitable means including memory sharing, message passing, token passing, network transmission, etc.

One or more example embodiments provide active pixel sensor (APS) arrays for complementary-metal-oxide-semiconductor (CMOS) image sensors. The APS arrays utilize a stacked pixel sensor structure allowing for transfer of charge from a pinned photodiode structure on a top chip (or substrate) to a pixel capacitor on a bottom chip (or substrate) of a given pixel, while employing a standard four transistor (4T) readout circuit for the pixel on the lower chip.

According to one or more example embodiments, the charge transfer via connection between the upper chip and the lower chip may be shared among several pixels of the APS array. Although example embodiments are described herein with regard to vias being shared among several pixels, each pixel may have a dedicated via to enable full-frame global shutter operation.

Example embodiments also provide image sensors and electronic systems including APS arrays, and methods for capturing images.

According to at least some example embodiments, image sampling may be performed by charge transfer and without biasing and/or double sampling.

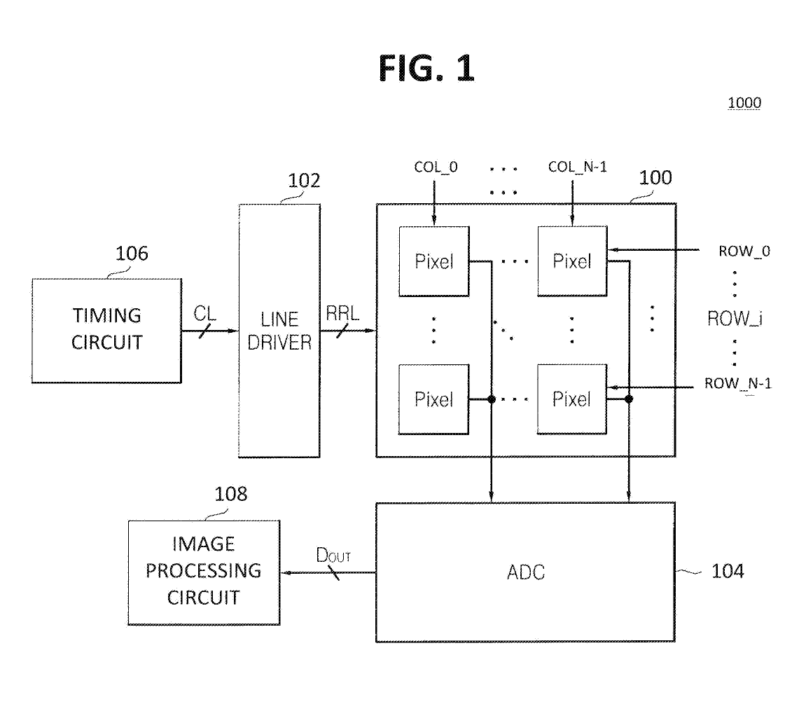

FIG. 1 is a block diagram of an image sensor 1000 according to an example embodiment. In the example shown in FIG. 1, the images sensor 1000 is a complementary-metal-oxide-semiconductor (CMOS) image sensor. However, example embodiments should not be limited to this example.

Referring to FIG. 1, a timing circuit 106 controls a line driver 102 through one or more control lines CL. In one example, the timing circuit 106 causes the line driver 102 to generate a plurality of transfer pulses (e.g., reset/shutter, sampling, readout, and/or selection). The line driver 102 outputs the transfer pulses to a pixel array 100 over a plurality of read and reset lines RRL. The read and reset lines RRL may include transfer lines, sampling lines, reset lines, and selection lines.

The pixel array 100 includes a plurality of pixels arranged in an array of rows ROW_0, . . . , ROW_i, . . . , ROW_N−1 and columns COL_0, . . . , COL_i, . . . , COL_N−1. As discussed herein, rows and columns may be collectively referred to as lines. Each of the plurality of read and reset lines RRL corresponds to a line of pixels in the pixel array 100 having a Bayer color pattern. In the example embodiment shown in FIG. 1, each pixel is an active-pixel sensor (APS), and the pixel array 100 is an APS array.

As is known, in the Bayer color pattern, ‘R’ represents a pixel for sensing read color light, and ‘B’ represents a pixel for sensing blue color light. ‘Gb’ represents a pixel for sensing green color light in a row having alternating green and blue pixels, and ‘Gr’ represents a pixel for sensing green color light in a row having alternating green and red pixels.

Still referring to FIG. 1, the analog-to-digital converter (ADC) 104 converts the output pixel data (e.g., voltages) from the i-th line ROW_i of readout pixels into a digital signal (also referred to herein as image data). The ADC 104 then outputs the image data to the image processing circuit 108. The image processing circuit 108 performs further processing so as to generate an image to be displayed on a display device (e.g., monitor, etc.) and/or stored in a memory (not shown).

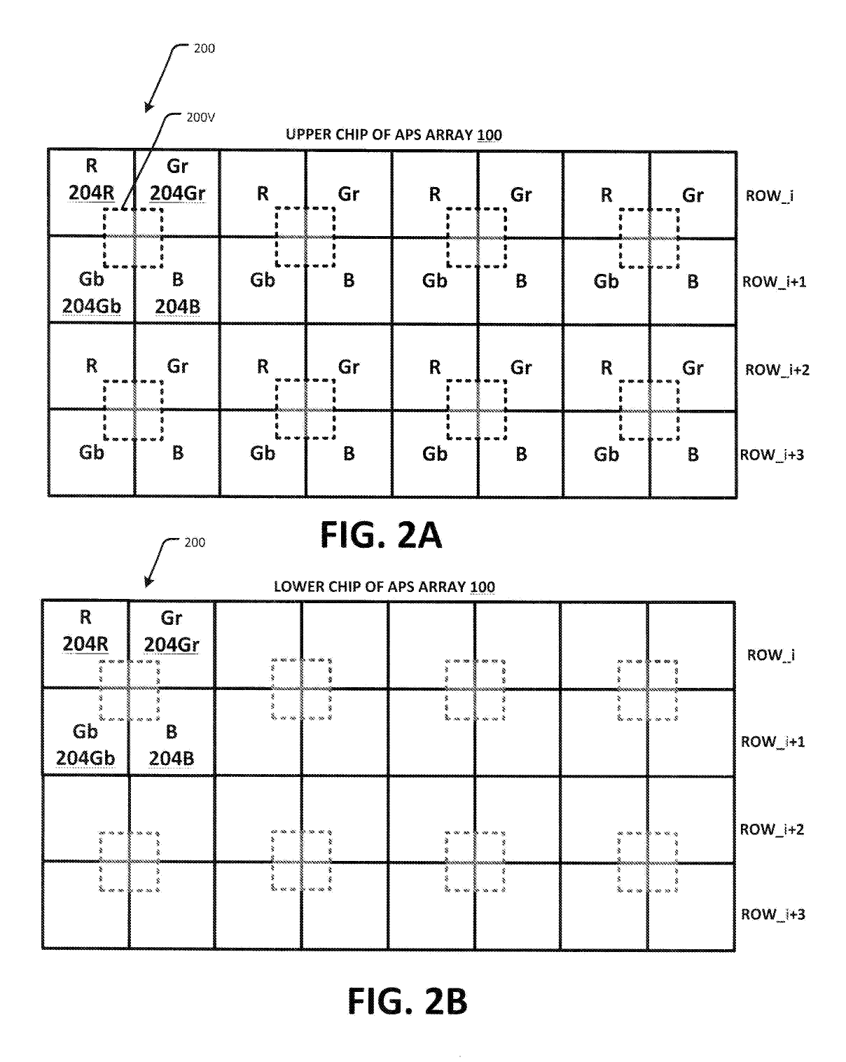

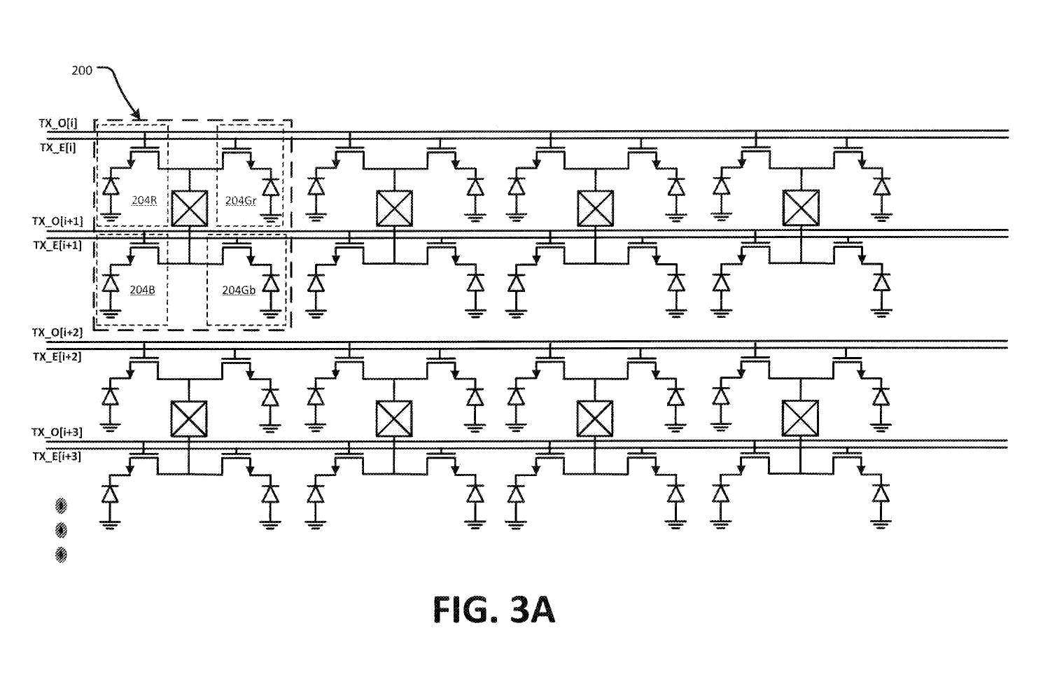

As discussed in more detail below with regard to FIGS. 2A through 5, the APS array 100 shown in FIG. 1 has a stacked pixel structure in which a photodiode and transfer circuit portion of each pixel circuit is formed on an upper chip (or substrate), and a sample and readout circuit portion of each pixel circuit is formed on a lower chip (or substrate). In at least one example embodiment, the upper chip includes only the photodiode and transfer circuit portion of each pixel circuit.

Example embodiments will be described with regard to pixels including a photodiode and a transfer transistor for the purposes of simplification and explanation of example embodiments. However, it should be understood that example embodiments may be implemented utilizing pinned photodiode structures comprised of a photodiode and transfer transistor.

FIG. 2A illustrates portions of four adjacent rows ROW_i through ROW_i+3 of an example embodiment of an upper chip of the APS array 100 shown in FIG. 1. FIG. 2B illustrates portions of four adjacent rows ROW_i through ROW_i+3 of an example embodiment of a lower chip of the APS array 100 shown in FIG. 1.

Referring in more detail to FIG. 2A, an array of pixels is arranged in a Bayer pattern. For each group of four pixels red (R), green-red (Gr), green-blue (Gb), and blue (B), the photodiode and transfer circuit portion(s) of the pixel circuit on the upper chip is (are) electrically connected to the sample and readout circuit portion of the pixel circuit on the lower chip by a via 200V. In this regard, each group of pixels shares a single via 200V.

Example embodiments will be discussed herein with regard to a pixel group 200, which includes a red pixel 204R, a green-red pixel 204Gr, a green-blue pixel 204Gb, and a blue pixel 204B. However, it should be understood that each group of four pixels may be structured and/or operate in the same or substantially the same manner.

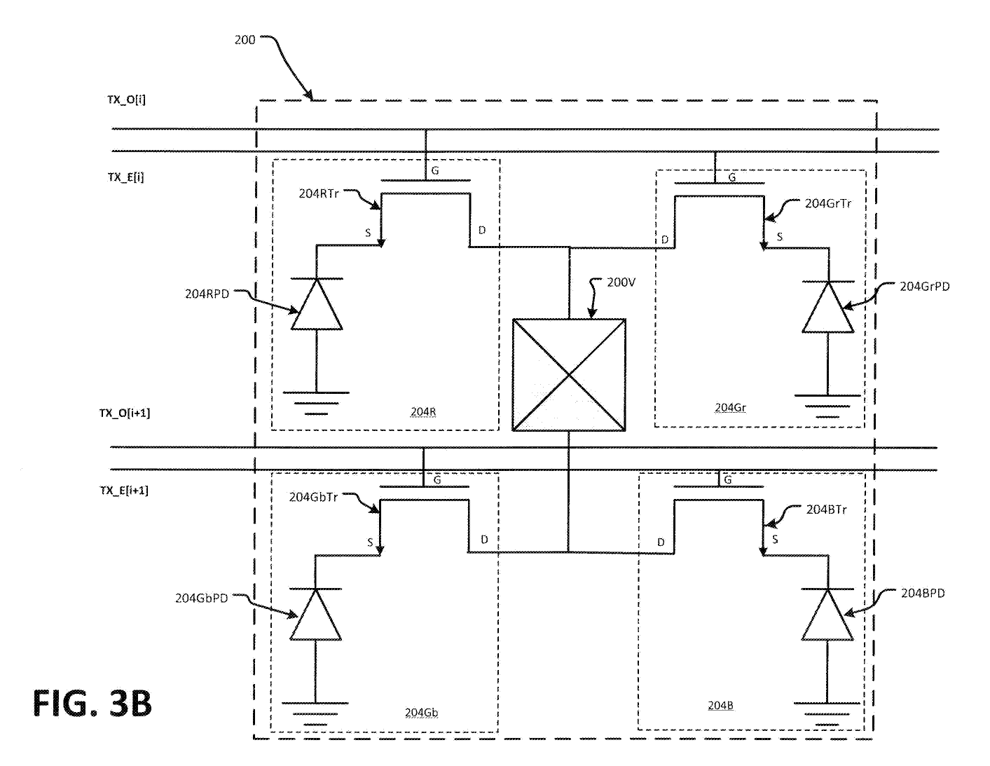

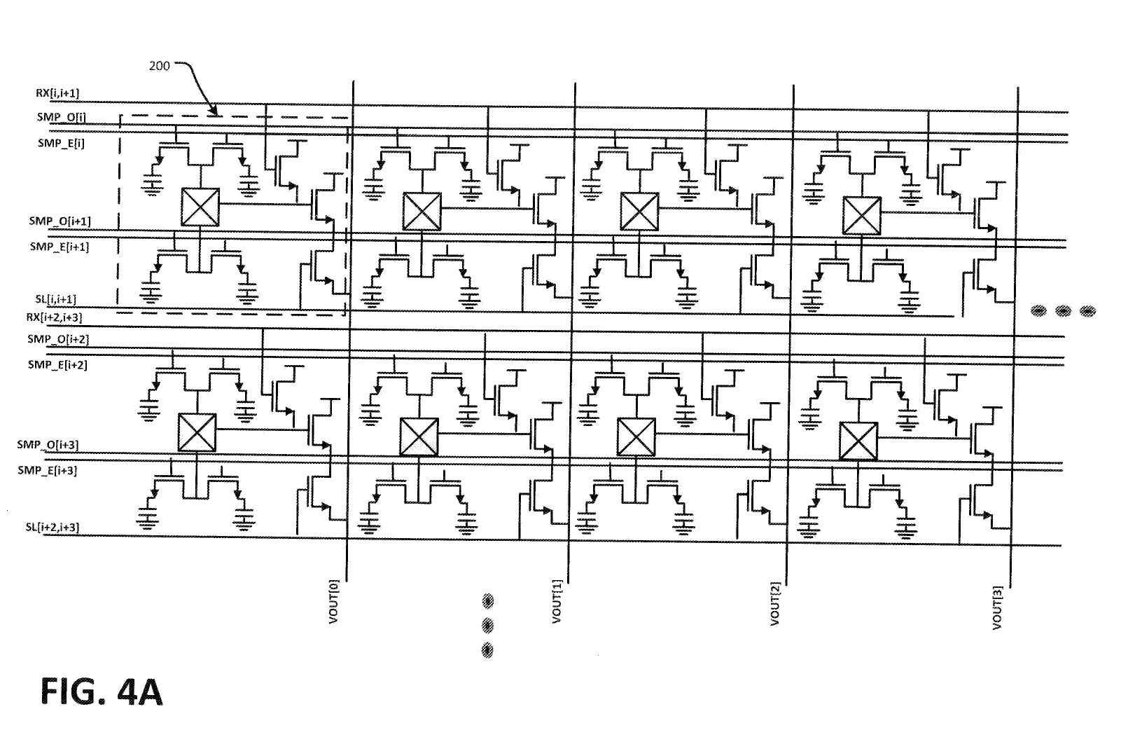

FIG. 3A is a circuit diagram illustrating an example embodiment of the photodiode and transfer circuit portion of the pixel circuit on the upper chip shown in FIG. 2A. FIG. 3B is a more detailed circuit diagram illustrating the photodiode and transfer circuit portions for each of pixels 204R, 204Gr, 204Gb and 204B shown in FIG. 3A. The pixel group 200 may also be referred to as a unit pixel, and the pixels 204R, 204Gr, 204Gb and 204B referred to as subpixels in this context.

Referring to FIGS. 3A and 3B, the red pixel 204R includes a photodiode 204RPD and a transfer transistor 204RTr. The green-red pixel 204Gr includes a photodiode 204GrPD and a transfer transistor 204GrTr. The green-blue pixel 204Gb includes a photodiode 204GbPD and a transfer transistor 204GbTr. The blue pixel 204B includes a photodiode 204BPD and a transfer transistor 204BTr.

In this example, the transfer transistors 204RTr, 204GrTr, 204GbTr and 204BTr are N-channel metal-oxide semiconductor field effect transistors (MOSFETs). However, it should be understood that any suitable switching devices, transistors and/or circuits may be used.

Still referring to FIGS. 3A and 3B, the anode of the photodiode 204RPD is connected to ground, and the cathode of the photodiode 204RPD is connected to the source S of the transfer transistor 204RTr. The drain D of the transfer transistor 204RTr is electrically coupled to the sample and readout circuit portion of the pixel circuit on the lower chip through the via 200V. The gate G of the transfer transistor 204RTr is electrically coupled to transfer line TX_O[i]. The transfer line TX_O[i] is electrically coupled to gates G of transfer transistors for pixels in odd columns of the i-th row ROW_i of pixels of the APS array.

The anode of the photodiode 204GrPD is connected to ground, and the cathode of the photodiode 204GrPD is connected to the source S of the transfer transistor 204GrTr. The drain D of the transfer transistor 204GrTr is electrically coupled to the drain D of the transfer transistor 204RTr and to the sample and readout circuit portion of the pixel circuit on the lower chip through the via 200V. The gate G of the transfer transistor 204GrTr is electrically coupled to transfer line TX_E[i]. The transfer line TX_E[i] is electrically coupled to gates of transfer transistors for pixels in even columns of the i-th row ROW_i of pixels of the APS array.

The anode of the photodiode 204GbPD is connected to ground, and the cathode of the photodiode 204GbPD is connected to the source S of the transfer transistor 204GbTr. The drain D of the transfer transistor 204GbTr is electrically coupled to the drains D of the transfer transistors 204RTr and 204GrTr, and to the sample and readout circuit portion of the pixel circuit on the lower chip through the via 200V. The gate G of the transfer transistor 204GbTr is electrically coupled to transfer line TX_O[i+1]. The transfer line TX_O[i+1] is electrically coupled to gates of transfer transistors of pixels in odd columns of the (i+1)-th row ROW_i+1 of pixels of the APS array.

The anode of the photodiode 204BPD is connected to ground, and the cathode of the photodiode 204BPD is connected to the source S of the transfer transistor 204BTr. The drain D of the transfer transistor 204BTr is electrically coupled to the drains D of the transfer transistors 204RTr, 204GrTr and 204GbTr, and to the sample and readout circuit portion of the pixel circuit on the lower chip through the via 200V. The gate G of the transfer transistor 204BTr is electrically coupled to transfer line TX_E[i+1]. The transfer line TX_E[i+1] is electrically coupled to gates G of transfer transistors of pixels in even columns of the (i+1)-th row ROW_i+1 of pixels of the APS array.

As discussed above, the photodiode and transfer circuit portions of pixels on the upper chip of the APS array 100 are electrically coupled to the sample and readout circuits on the lower chip of the APS array 100 by vias 200V. In this example, each group of pixels 200 shares a via 200V.

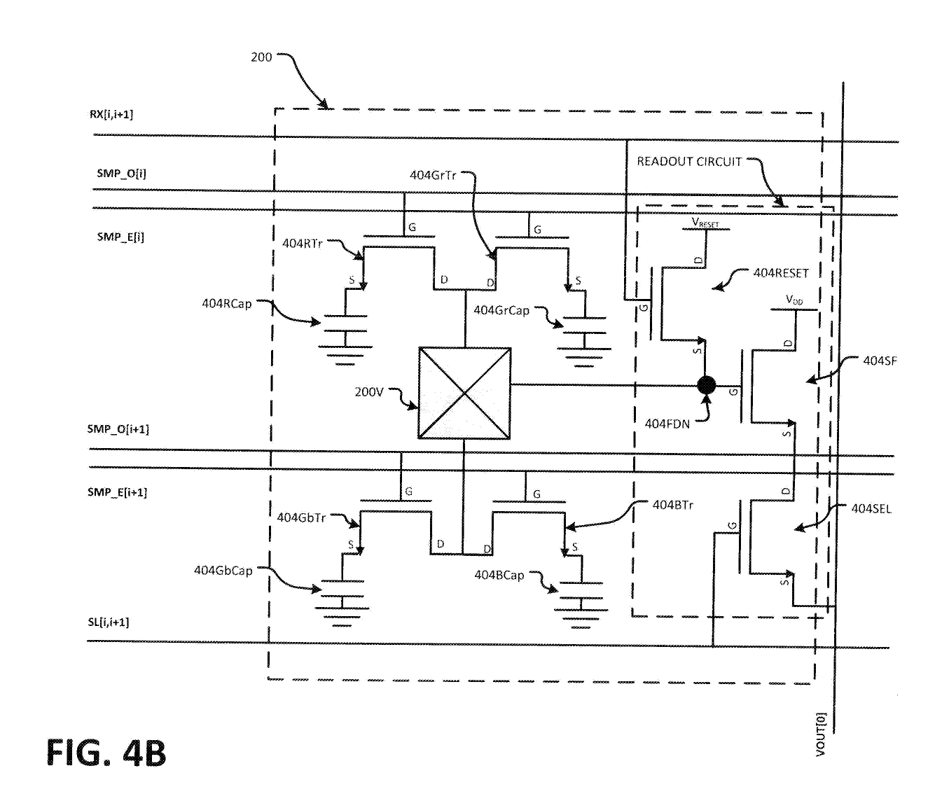

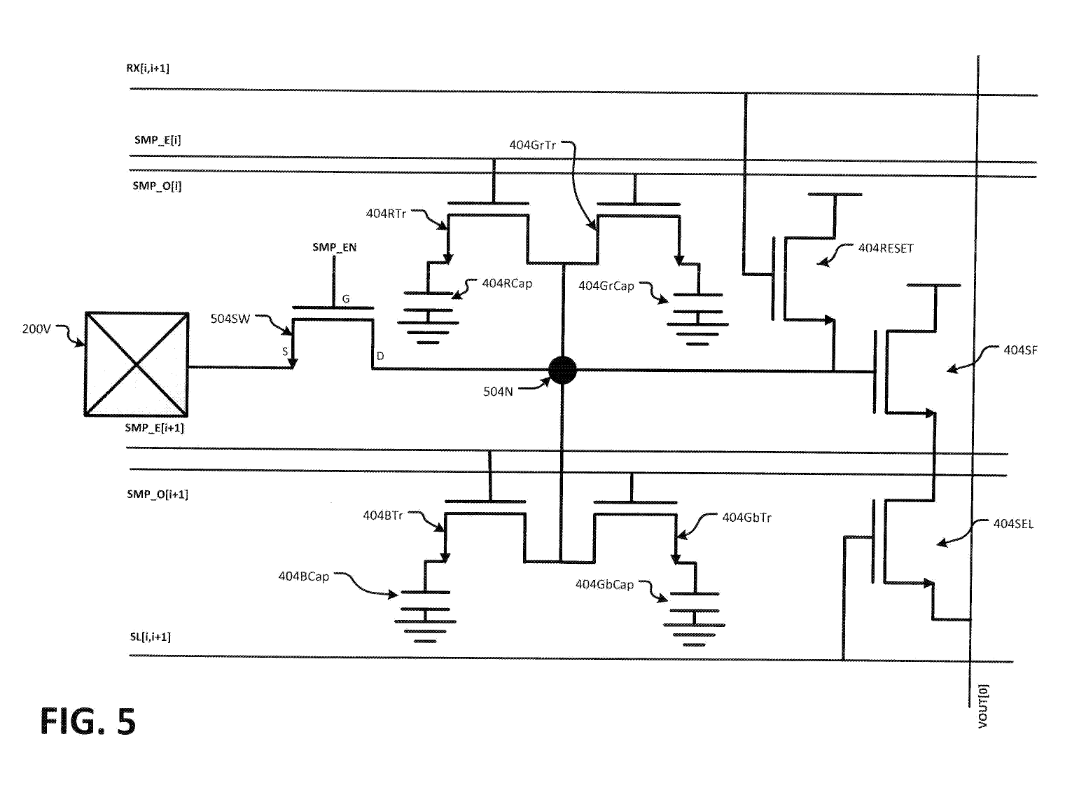

FIG. 4A is a circuit diagram illustrating a portion of a pixel circuit on the lower chip shown in FIG. 2B, according to an example embodiment. In more detail, FIG. 4A illustrates the sample and readout circuit portions on the lower chip shown in FIG. 2B. FIG. 4B is a more detailed circuit diagram of a sample and readout circuit portion corresponding to the photodiode and transfer circuit portion shown in FIG. 3B.

Referring to FIGS. 4A and 4B, the sample and readout circuit portions are arranged on the lower chip in an array of rows and columns. Each of the sample and readout circuit portions corresponds to photodiode and transfer circuit portions of a group of pixels. In this regard, each group of pixels shares a via 200V electrically connecting the circuits (or circuit portions) on the upper chip to the circuits (or circuit portions) on the lower chip of the APS array 100.

The sample and readout circuit portions for the pixels in the i-th and (i+1)-th rows ROW_i and ROW_(i+1) of the APS array are electrically coupled to a reset line RX[i,i+1], i-th sampling lines SMP_E[i] and SMP_O[i], (i+1)-th sampling lines SMP_E[i+1] and SMP_O[i+1], and a selection line SL[i,i+1].

The sample and readout circuit portions for pixels in the (i+2)-th and (i+3)-th rows ROW_i+2 and ROW_i+3 are electrically connected to a reset line RX[i+2,i+3], (i+2)-th sampling lines SMP_E[i+2] and SMP_O[i+2], (i+3)-th sampling lines SMP_E[i+3] and SMP_O[i+3], and a selection line SL[i+2,i+3].

The sample and readout circuit portions in a given column are electrically coupled to a corresponding one of output lines VOUT[0], VOUT[1], VOUT[2], VOUT[3], etc. The APS array 100 outputs pixel data to the ADC 104 via the output lines VOUT[0], VOUT[1], VOUT[2], VOUT[3]. According to example embodiments, a bias sink current is applied to the output lines VOUT[0], VOUT[1], VOUT[2], VOUT[3] (before analog-to-digital conversion (ADC)) to enable functionality of the source-follower transistors.

In FIGS. 4A and 4B, the sample and readout circuit portion includes a readout circuit and a plurality of sample and hold circuits. Each of the plurality of sample and hold circuits includes a sample and hold (SH) transistor and a pixel capacitor, and corresponds to a photodiode and transfer circuit for one of the pixels 204R, 204Gr, 204Gb and 204B.

In more detail with regard to FIG. 4B, the sample and hold circuit for the red pixel 204R includes a pixel capacitor 404RCap and a sample and hold transistor 404RTr.

The sample and hold circuit for the green-red pixel 204Gr includes a pixel capacitor 404GrCap and a sample and hold transistor 404GrTr.

The sample and hold circuit for the green-blue pixel 204Gb includes a pixel capacitor 404GbCap and a sample and hold transistor 404GbTr.

The sample and hold circuit for the blue pixel 204B includes a pixel capacitor 404BCap and a sample and hold transistor 404BTr.

Still referring to FIG. 4B, the readout circuit includes: a reset transistor 404RESET; a source-follower transistor 404SF; and a selection transistor (also referred to as select transistor) 404SEL.

The gate G of the source-follower transistor 404SF is connected to the source S of the reset transistor 404RESET at node 404FND, which is a floating diffusion region. As is generally well-known, a floating diffusion region can be viewed as a capacitor or a deep potential well, which absorbs charges (e.g., all charges) from a photodiode. The capacitance of the floating diffusion region determines the conversion gain of the pixel; that is, how much voltage change is obtained per unit of charge.

A first electrode of the pixel capacitor 404RCap is coupled to ground, and a second electrode of the pixel capacitor 404RCap is electrically coupled to the source S of the sample and hold transistor 404RTr. The gate G of the sample and hold transistor 404RTr is electrically coupled to the sampling line SMP_O[i]. The drain D of the sample and hold transistor 404RTr is electrically coupled to the photodiode and transfer circuit portion on the upper chip, the drain D of each of the sample and hold transistors 404GrTr, 404BTr and 404GbTr, the source S of the reset transistor 404RESET and the gate G of the source-follower transistor 404SF through the via 200V.

A first electrode of the pixel capacitor 404GrCap is coupled to ground, and a second electrode of the pixel capacitor 404GrCap is electrically coupled to the source S of the sample and hold transistor 404GrTr. The gate G of the sample and hold transistor 404GrTr is electrically coupled to the sampling line SMP_E[i]. The drain D of the sample and hold transistor 404GrTr is electrically coupled to the photodiode and transfer circuit portion on the upper chip, the drain D of each of the sample and hold transistors 404RTr, 404BTr and 404GbTr, the source S of the reset transistor 404RESET and the gate G of the source-follower transistor 404SF through the via 200V.

A first electrode of the pixel capacitor 404GbCap is coupled to ground, and a second electrode of the pixel capacitor 404GbCap is electrically coupled to the source S of the sample and hold transistor 404GbTr. The gate G of the sample and hold transistor 404GbTr is electrically coupled to the sampling line SMP_O[i+1]. The drain D of the sample and hold transistor 404GbTr is electrically coupled to the photodiode and transfer circuit portion on the upper chip, the drain D of each of the sample and hold transistors 404RTr, 404GrTr and 404BTr, the source S of the reset transistor 404RESET and the gate G of the source-follower transistor 404SF through the via 200V.

A first electrode of the pixel capacitor 404BCap is coupled to ground, and a second electrode of the pixel capacitor 404BCap is electrically coupled to the source S of the sample and hold transistor 404BTr. The gate G of the sample and hold transistor 404BTr is electrically coupled to the sampling line SMP_E[i+1]. The drain D of the sample and hold transistor 404BTr is electrically coupled to the photodiode and transfer circuit portion on the upper chip, the drain D of each of the sample and hold transistors 404RTr, 404GrTr and 404GbTr, the source S of the reset transistor 404RESET and the gate G of the source-follower transistor 404SF through the via 200V.

Still referring to FIG. 4B, the drain D of the reset transistor 404RESET is connected to a reset voltage V_{RESET}, and the gate G of the reset transistor 404RESET is electrically coupled to reset line RX[i,i+1].

The drain D of the source-follower transistor 404SF is connected to a voltage V_{DD}, and the source S of the source-follower transistor 404SF is electrically coupled to the drain D of the selection transistor 404SEL.

The gate G of the selection transistor 404SEL is electrically coupled to the select line SL[i,i+1]. The source S of the selection transistor 404SEL is electrically coupled to output line VOUT[0].

As discussed above, in FIGS. 4A and 4B, the node 404FND connecting the gate G of the source-follower transistor 404SF and the source S of the reset transistor 404RESET is a floating diffusion region.

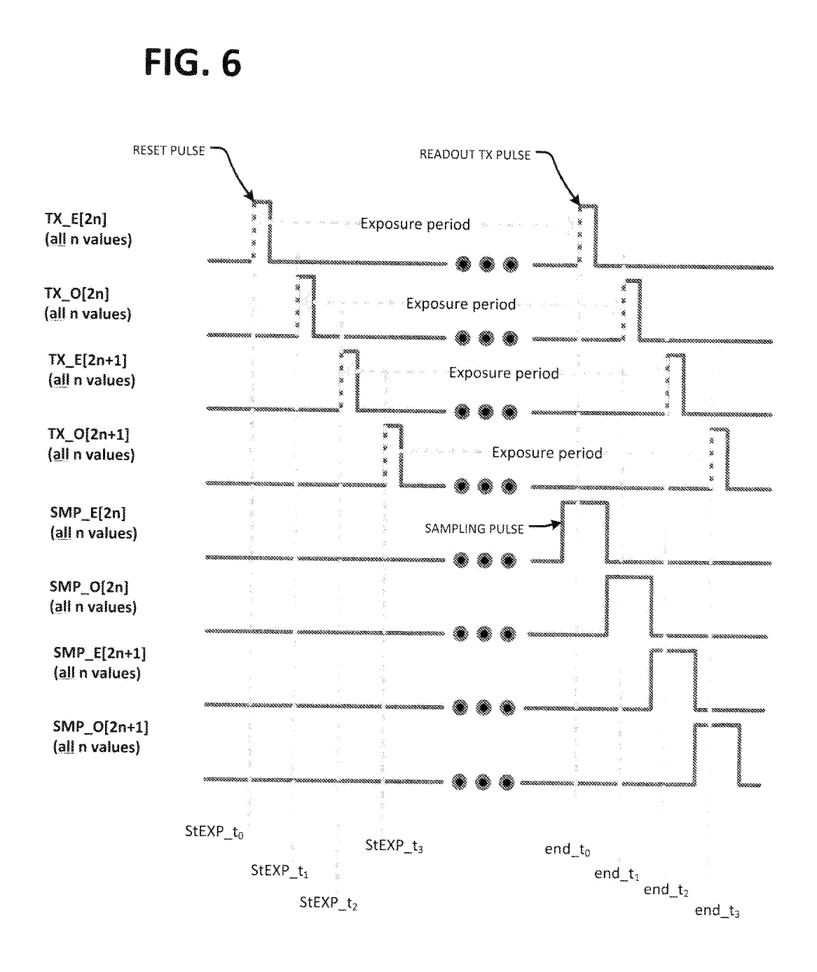

FIG. 5 illustrates an alternative structure of a sample and readout circuit portion on a lower chip, according to an example embodiment. The example embodiment shown in FIG. 5 is similar to the example embodiment shown in FIG. 4B, but further includes a control switch (transistor) 504SW connected between the via 200V and a node (floating diffusion node) 504N at which the drain D of each of the sample and hold transistors 404RTr, 404GrTr, 404GbTr, 404BTr, the source S of the reset transistor 404RESET and the gate G of the source-follower transistor 404SF are connected. In the example embodiment shown in FIG. 5, the source S of the control transistor 504SW is electrically coupled to the via 200V and the drain S is electrically coupled to the node 504N. The gate G of the control transistor 504SW is coupled to a sampling enable signal SMP_EN. The control transistor 504SW is controlled to be in an ON state during a sampling phase and in an OFF state during the readout phase of the APS array.

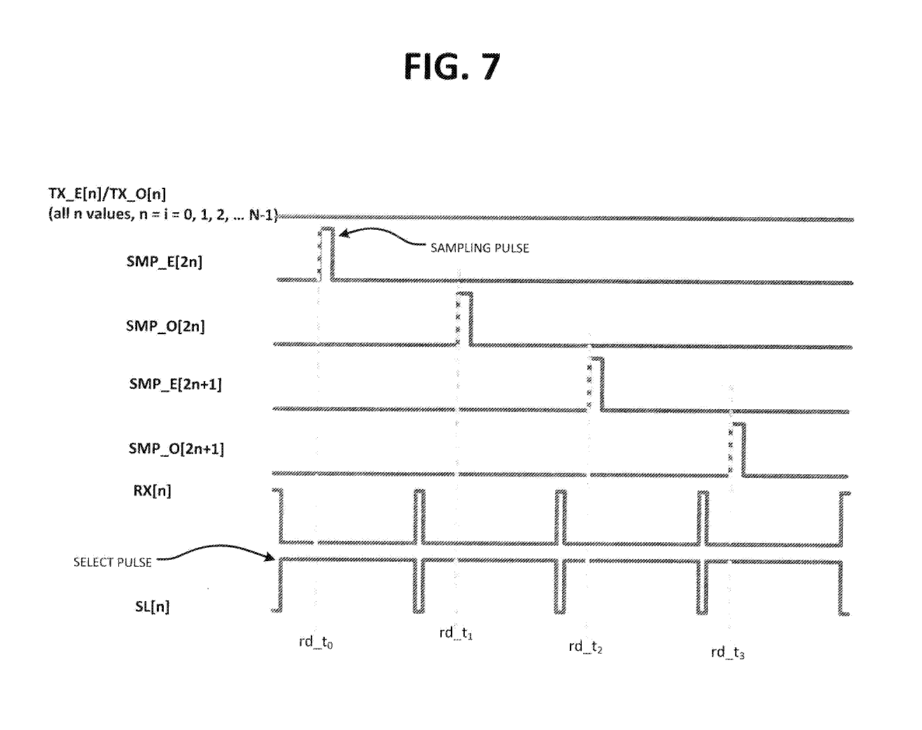

Example operation of the APS array 100 and the circuits shown in FIGS. 3A through 4B will be described in more detail below with regard to FIGS. 6 and 7. Together, FIGS. 6 and 7 also illustrate a method for capturing an image according to an example embodiment.

FIG. 6 is a timing diagram for describing example operation of the APS array 100 during an exposure period (also sometimes referred to as an integration period).

The timing diagram shown in FIG. 6 illustrates transfer pulses applied to transfer lines and sampling lines that are electrically connected to the APS array 100 shown in FIG. 1. In this regard, transfer lines TX_E[2n] are transfer lines connected to pixels in even rows and even columns of the APS array 100, transfer lines TX_O[2n] are transfer lines connected to pixels in even rows, but odd columns of the APS array 100, transfer lines TX_E[2n+1] are transfer lines connected to pixels in odd rows, but even columns of the APS array 100, and transfer lines TX_O[2n+1] are transfer lines connected to pixels in odd rows and odd columns of the APS array 100. Although not shown in FIG. 6, RX[n] represents the reset lines connected to respective rows of the APS array 100, and SL[n] represents selection lines connected to respective rows of the APS array 100.

In FIG. 6, n is a value between 0 and N−1, and the number of rows in the APS array 100 is N−1. In at least some cases, the example shown in FIG. 6 will be described with regard to the portion of the APS array 100 shown in FIGS. 3A through 4B.

Referring to FIG. 6, according to at least one example embodiment the line driver 102 triggers exposure (and start of the exposure period or interval) of the APS array 100 by sequentially applying a reset transfer pulse (also referred to as a reset pulse or a shutter pulse) to transfer lines TX_E[2n], TX_O[2n], TX_E[2n+1], and TX_O[2n+1]. During the exposure period, the photodiodes at each pixel produce and accumulate charges in response to incident light to generate image data later used to obtain an image. During the exposure period, the reset transistors may be maintained in the ON state by applying a logic high signal to the reset lines RX[n], whereas the select lines SL[n] may be maintained at a logic low level such that the select transistors remain in the OFF state.

In more detail, at time StEXP_t₀ the line driver 102 applies a reset transfer pulse to the transfer lines TX_E[2n] to initiate an exposure period for pixels of the APS array 100 connected to the transfer lines TX_E[2n]; at time StEXP_t₁ the line driver 102 applies a reset transfer pulse to the transfer lines TX_O[2n] to trigger an exposure period for the pixels of the APS array 100 connected to the transfer lines TX_O[2n]; at time StEXP_t₂ the line driver 102 applies a reset transfer pulse to the transfer lines TX_E[2n+1] to initiate an exposure period for the pixels of the APS array 100 connected to the transfer lines TX_E[2n+1]; and at time StEXP_t₃ the line driver 102 applies a reset transfer pulse to the transfer lines TX_O[2n+1] to trigger an exposure period for the pixels of the APS array 100 connected to the transfer lines TX_O[2n+1].

Still referring to FIG. 6, at time end to the line driver 102 applies a readout transfer pulse to the transfer lines TX_E[2n] to end the exposure period for the pixels connected to the transfer lines TX_E[2n]. Concurrently with the application of the readout transfer pulse, the line driver 102 applies a sampling pulse to the sampling lines SMP_E[2n]. In this example, the duration of the sampling pulse is greater than the duration of the readout transfer pulse. Concurrently with the application of the sampling pulse, the line driver 102 may apply a logic low signal to the reset lines RX[n] to switch the reset transistor 404RESET to the OFF state. The line driver 102 may continue to apply a logic low signal to the reset lines RX[n] until exposure of the APS array 100 is complete.

In response to the application of the readout transfer pulse and corresponding sampling pulse to the transfer lines TX_E[2n] and sampling lines SMP_E[2n] at time end_t₀, pixel data signals (e.g., in the form of accumulated charges and/or voltage) are output by the photodiodes of pixels connected to the transfer lines TX_E[2n] and stored in respective pixel capacitors.

At time end_t₁, the line driver 102 applies a readout transfer pulse to the transfer lines TX_O[2n] to end the exposure period for the pixels connected to the transfer lines TX_O[2n]. Concurrently with the application of the readout transfer pulse, the line driver 102 applies a sampling pulse to the sampling lines SMP_O[2n]. In this example, the duration of the sampling pulse is greater than the duration of the readout transfer pulse.

In response to the application of the readout transfer pulse and corresponding sampling pulse to the transfer lines TX_O[2n] and sampling lines SMP_O[2n] at time end_t₁, pixel data signals (e.g., in the form of accumulated charges and/or voltage) are output by the photodiodes of pixels connected to the transfer lines TX_O[2n] and stored in respective pixel capacitors.

At time end_t₂ the line driver 102 applies a readout transfer pulse to the transfer lines TX_E[2n+1] to end the exposure period for the pixels connected to the transfer lines TX_E[2n+1]. Concurrently with the application of the readout transfer pulse, the line driver 102 applies a sampling pulse to the sampling lines SMP_E[2n+1]. The duration of the sampling pulse is again greater than the duration of the readout transfer pulse.

In response to the application of the readout transfer pulse and corresponding sampling pulse to the transfer lines TX_E[2n+1] and sampling lines SMP_E[2n+1] at time end_t₂, pixel data signals (e.g., in the form of accumulated charges and/or voltage) are output by the photodiodes of pixels connected to the transfer lines TX_E[2n+1] and stored in respective pixel capacitors.

At time end_t₃ the line driver 102 applies a readout transfer pulse to the transfer lines TX_O[2n+1] to end the exposure period for the pixels connected to the transfer lines TX_O[2n+1]. Concurrently with the application of the readout transfer pulse, the line driver 102 applies a sampling pulse to the sampling lines SMP_O[2n+1]. In this example, the duration of the sampling pulse is greater than the duration of the readout transfer pulse.

In response to the application of the readout transfer pulse and corresponding sampling pulse to the transfer lines TX_O[2n+1] and sampling lines SMP_O[2n+1] at time end_t₃, pixel data signals (e.g., in the form of accumulated charges and/or voltage) are output by the photodiodes of pixels connected to the transfer lines TX_O[2n+1] and stored in respective pixel capacitors.

As shown in FIG. 6, according to at least this example embodiment, the exposure periods for groups of pixels connected to corresponding sets of transfer lines TX_E[2n], TX_O[2n], TX_E[2n+1], and TX_O[2n+1] overlap (e.g., substantially overlap) with one another.

After expiration (at the end) of the exposure period (or interval), the stored pixel data signals (also sometimes referred to herein as pixel data) are readout from the pixels as discussed below with regard to the timing diagram shown in FIG. 7.

FIG. 7 is a timing diagram for describing rolling readout of the APS array 100 during a readout period. During a rolling readout, pixel data is readout from the APS array 100 using a rolling readout method in which sampling pulses are applied to groups of sampling lines SMP_E[2n], SMP_O[2n], SMP_E[2n+1], and SMP_O[2n+1] sequentially.

Referring to FIG. 7, after the exposure periods end, the line driver 102 applies sampling pulses sequentially to each group of sampling lines SMP_E[2n], SMP_O[2n], SMP_E[2n+1], and SMP_O[2n+1] to perform a rolling readout of respective pixel capacitors (e.g., 404GrCap, 404RCap, 404BCap, and 404GrCap) of pixels connected to respective groups of sampling lines. In more detail, at time rd_t₀ the line driver 102 applies a sampling pulse to sampling lines SMP_E[2n] to read out pixel data stored at pixels connected to the sampling lines SMP_E[2n]; at time rd_t₁ the line driver 102 applies a sampling pulse to sampling lines SMP_O[2n] to read out pixel data stored at pixels connected to the sampling lines SMP_O[2n]; at time rd_t₂ the line driver 102 applies a sampling pulse to sampling lines SMP_E[2n+1] to read out pixel data stored at pixels connected to the sampling lines SMP_E[2n+1]; and at time rd_t₃ the line driver 102 applies a sampling pulse to sampling lines SMP_O[2n+1] to read out pixel data stored at pixels connected to the sampling lines SMP_O[2n+1].

A select pulse is applied to the selection lines SL[n] concurrently with each of the sampling pulses to switch the select transistor 404SEL to the ON state such that the pixel data stored in the pixel capacitors is output via a respective output line. While the selection lines SL[n] are at a logic high level and the select transistors are active, a logic low signal is applied to the reset lines RX[n] to switch the reset transistors to the OFF state.

A more specific discussion of the timing diagrams shown in FIGS. 6 and 7 will now be provided with regard to the circuit diagrams in FIGS. 3B and 4B. In this example, 2n=i.

Referring to FIGS. 3B, 4B and 6, the line driver 102 applies a reset transfer pulse to the transfer line TX_E[i] at time StEXP_t₀ to initiate exposure of the green-red pixel 204Gr; the line driver 102 applies a reset transfer pulse to the transfer line TX_O[i] at time StEXP_t₁ to initiate exposure of the red pixel 204R; the line driver 102 applies a reset transfer pulse to the transfer line TX_E[i+1] at time StEXP_t₂ to initiate exposure of the blue pixel 204B; and the line driver 102 applies a reset transfer pulse to the transfer line TX_O[i+1] at time StEXP_t₃ to initiate exposure of the green-blue pixel 204Gb.

The reset transfer pulse applied to transfer line TX_E[i] activates the transfer transistor 204GrTr; the reset transfer pulse applied to transfer line TX_O[i] activates the transfer transistor 204RTr; the reset transfer pulse applied to the transfer line TX_E[i+1] activates the transfer transistor 204BTr; and the reset transfer pulse applied to the transfer line TX_O[i+1] activates the transfer transistor 204GbTr.

At time end_t₀, the line driver 102 applies a readout transfer pulse to the transfer line TX_E[i] to end exposure of the green-red pixel 204Gr. Concurrently with the application of the readout transfer pulse, the line driver 102 applies a sampling pulse to the sampling line SMP_E[i].

The reset transfer pulse applied to the transfer line TX_E[i] at time end_t₀ activates the transfer transistor 204GrTr, and the sampling pulse activates the sample and hold transistor 404GrTr. While both transistors 204GrTr and 404GrTr are active (ON), the pixel data signal generated by the photodiode 204GrPD on the upper chip is output to and stored at the pixel capacitor 404GrCap on the lower chip through the via 200V electrically connecting the upper chip to the lower chip.

At time end_t₁, the line driver 102 applies a readout transfer pulse to the transfer line TX_O[i] to end exposure of the red pixel 204R. Concurrently with the application of the readout transfer pulse, the line driver 102 applies a sampling pulse to the sampling line SMP_O[i].

The readout transfer pulse applied to the transfer line TX_O[i] at time end_t₁ activates the transfer transistor 204RTr, and the sampling pulse activates the sample and hold transistor 404RTr. While both transistors 204RTr and 404RTr are activated (ON), the pixel data signal generated by the photodiode 204RPD on the upper chip is output to and stored at the pixel capacitor 404RCap on the lower chip through the via 200V electrically connecting the upper chip to the lower chip.

At time end_t₂ the line driver 102 applies a readout transfer pulse to the transfer line TX_E[i+1] to end exposure of the blue pixel 204B. Concurrently with the application of the readout transfer pulse, the line driver 102 applies a sampling pulse to the sampling line SMP_E[i+1].

The readout transfer pulse applied to the transfer line TX_E[i+1] at time end_t₂ activates the transfer transistor 204BTr, and the sampling pulse activates the sample and hold transistor 404BTr. While both transistors 204BTr and 404BTr are activated (ON), the pixel data signal generated by the photodiode 204BPD on the upper chip is output to and stored at the pixel capacitor 404BCap on the lower chip through the via 200V electrically connecting the upper chip to the lower chip.

At time end_t₃, the line driver 102 applies a readout transfer pulse to the transfer line TX_O[i+1] to end exposure of the green-blue pixel 204Gb. Concurrently with the application of the readout transfer pulse, the line driver 102 applies a sampling pulse to the sampling line SMP_O[i+1].

The readout transfer pulse applied to the transfer line TX_O[i+1] at time end_t₃ activates the transfer transistor 204GbTr, and the sampling pulse activates the sample and hold transistor 404GbTr. While both transistors 204GbTr and 404GbTr are activated (ON), the pixel data generated by the photodiode 204GbPD on the upper chip is output to and stored at the pixel capacitor 404GbCap on the lower chip through the via 200V electrically connecting the upper chip to the lower chip.

Referring now to FIGS. 4B and 7, at time rd_t₀ the line driver 102 activates (or re-activates) the sample and hold transistor 404GrTr by applying a sampling pulse to the gate G of the sample and hold transistor 404GrTr via the sampling line SMP_E[i]. When the sample and hold transistor 404GrTr is activated, the pixel data signal stored in the pixel capacitor 404GrCap is readout and output through the sample and hold transistor 404GrTr to the gate G of the source-follower transistor 404SF. The source-follower transistor 404SF amplifies the pixel data signal readout from the pixel capacitor 404GrCap. The line driver 102 also activates the selection transistor 404SEL by applying a logic high signal to the selection line SL[i,i+1]. As a result, a pixel data signal amplified by the source-follower transistor 404SF is output to the ADC 104 via output line VOUT[0].

At time rd_t₁, the line driver 102 activates the sample and hold transistor 404RTr by applying a sampling pulse to the gate G of the sample and hold transistor 404RTr via the sampling line SMP_O[i]. When the sample and hold transistor 404RTr is activated, the pixel data signal stored in the pixel capacitor 404RCap is output through the sample and hold transistor 404RTr to the gate G of the source-follower transistor 404SF. The source-follower transistor 404SF amplifies the pixel data signal read out from the pixel capacitor 404RCap. The line driver 102 also activates the selection transistor 404SEL by applying a logic high signal to the selection line SL[i,i+1]. As a result, the pixel data signal amplified by the source-follower transistor 404SF is output to the ADC 104 via output line VOUT[0].

At time rd_t₂, the line driver 102 activates the sample and hold transistor 404BTr by applying a sampling pulse to the gate G of the sample and hold transistor 404BTr via the sampling line SMP_E[i+1]. When the sample and hold transistor 404BTr is activated, the pixel data signal stored in the pixel capacitor 404BCap is read out through the sample and hold transistor 404BTr to the gate G of the source-follower transistor 404SF. The source-follower transistor 404SF amplifies the pixel data signal read out from the pixel capacitor 404BCap. The line driver 102 also activates the selection transistor 404SEL by applying a logic high signal to the selection line SL[i,i+1]. As a result, the pixel data signal amplified by the source-follower transistor 404SF is output to the ADC 104 via output line VOUT[0].

At time rd_t₃, the line driver 102 activates the sample and hold transistor 404GbTr by applying a sampling pulse to the gate G of the sample and hold transistor 404GbTr via the sampling line SMP_O[i+1]. When the sample and hold transistor 404GbTr is activated, the pixel data signal stored in the pixel capacitor 404GbCap is output through the sample and hold transistor 404GbTr to the gate G of the source-follower transistor 404SF. The source-follower transistor 404SF amplifies the pixel data signal read out from the pixel capacitor 404GbCap. The line driver 102 also activates the selection transistor 404SEL by applying a logic high signal to the selection line SL[i,i+1]. As a result, the pixel data signal amplified by the source-follower transistor 404SF is output to the ADC 104 via Output line VOUT[0].

As mentioned above, FIG. 5 illustrates an alternative structure of a sample and readout circuit portion on a lower chip of the APS array 100, according to an example embodiment. The operation of the alternative structure shown in FIG. 5 is similar to the operation of the circuit shown in FIG. 4B, except for the additional control added by the control switch transistor 504SW. The control transistor 504SW is activated and deactivated based on the enable signal SMP_EN. In at least one example embodiment, the interval during which the control transistor 504SW is activated or ON (e.g., the enable signal SMP_EN is a logic high) overlaps with each of the sampling pulses shown in FIG. 6.

The control transistor 504SW in FIG. 5 reduces the capacitance of the floating diffusion region (504N) during readout. Effectively, during readout, the bottom side (or chip) of the pixel does not need to “see” the top side (or chip). Thus, during readout, the enable signal SMP_EN remains low such that the control transistor 504SW remains OFF or inactive, and electrically disconnects the top chip from the bottom chip of the pixel.

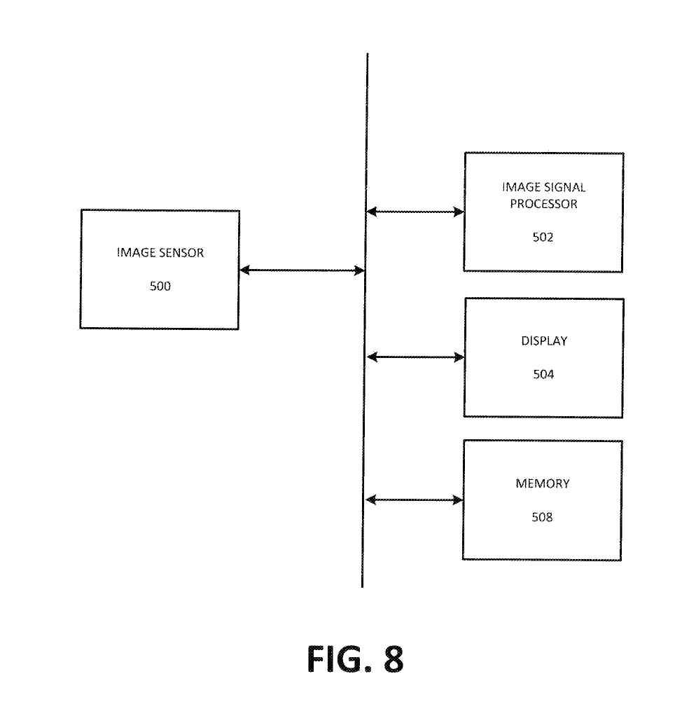

FIG. 8 is a block diagram illustrating an electronic imaging system according to an example embodiment.

Referring to FIG. 8, the electronic imaging system includes: an image sensor 500; an image signal processor (ISP) 502; a display 504; and a memory 508. The image sensor 500, the ISP 502, the display 504 and the memory 508 communicate with one another via a bus 506.

The image sensor 500 may be an image sensor according to example embodiments described herein. The image sensor 500 is configured to capture image data by converting optical images into electrical signals. The electrical signals are output to the ISP 502.

The ISP 502 processes the captured image data for storage in the memory 508 and/or display by the display 504. In more detail, the ISP 502 is configured to: receive digital image data from the image sensor 500; perform image processing operations on the digital image data; and output a processed image or processed image data. The ISP 502 may be or include the image processing circuit 108 shown in FIG. 1.

The ISP 502 may also be configured to execute a program and control the electronic imaging system. The program code to be executed by the ISP 502 may be stored in the memory 508. The memory 508 may also store the image data and/or images acquired by the image sensor and processed by the ISP 502. The memory 508 may be any suitable volatile or non-volatile memory.

The electronic imaging system shown in FIG. 8 may be connected to an external device (e.g., a personal computer or a network) through an input/output device (not shown) and may exchange data with the external device.

The electronic imaging system shown in FIG. 8 may embody various electronic control systems including an image sensor, such as a digital still camera. Moreover, the electronic imaging system may be used in, for example, mobile phones, personal digital assistants (PDAs), laptop computers, netbooks, MP3 players, navigation devices, household appliances, or any other device utilizing an image sensor or similar device.

The foregoing description of example embodiments has been provided for purposes of illustration and description. It is not intended to be exhaustive or limiting. Individual elements or features of a particular example embodiment are generally not limited to that particular example embodiment. Rather, where applicable, individual elements or features are interchangeable and may be used in a selected embodiment, even if not specifically shown or described. The same may also be varied in many ways. All such modifications are intended to be included within the scope of this disclosure.

1. A global shutter pixel having a stacked pixel structure, the pixel comprising:
a sample and readout circuit on a lower substrate, the sample and readout circuit being configured to store accumulated charge and output a pixel data signal corresponding to the stored accumulated charge; and
a photodiode and transfer circuit on an upper substrate, the photodiode and transfer circuit being configured to accumulate charge in response to incident light, and to transfer the accumulated charge to the sample and readout circuit, the upper substrate being stacked on the lower substrate.

2. The global shutter pixel of claim 1, wherein the sample and readout circuit is electrically connected to the photodiode and transfer circuit by a via between the upper substrate and the lower substrate.

3. The global shutter pixel of claim 2, further comprising:
a control switch between the via and the sample and readout circuit on the lower substrate, the control switch being configured to electrically disconnect the photodiode and transfer circuit from the sample and readout circuit during readout of the pixel data signal from the sample and readout circuit.

4. The global shutter pixel of claim 1, wherein the photodiode and transfer circuit is configured to transfer the accumulated charge directly to the sample and readout circuit without being stored on the upper substrate.

5. The global shutter pixel of claim 1, wherein the sample and readout circuit comprises:
a pixel capacitor configured to store the accumulated charge;
a sample and hold transistor coupled to the pixel capacitor, the sample and hold transistor being configured to readout the stored accumulated charge from the pixel capacitor in response to a sampling pulse; and
a readout circuit configured to output the pixel data signal corresponding to the accumulated charge in response to a select pulse.

6. The global shutter pixel of claim 5, wherein the readout circuit comprises:
a source-follower transistor configured to generate the pixel data signal based on the stored accumulated charge readout by the sample and hold transistor; and
a select transistor configured to output the pixel data signal in response to the select pulse.

7. An active pixel sensor comprising:
a plurality of unit pixels, each of the plurality of unit pixels including a plurality of subpixels, and each of the plurality of subpixels including,
a sample and readout circuit on a lower substrate, the sample and readout circuit being configured to store accumulated charge, and to output a pixel data signal corresponding to the stored accumulated charge, and
a photodiode and transfer circuit on an upper substrate, the upper substrate being stacked on the lower substrate, and the photodiode and transfer circuit being configured to accumulate charge in response to incident light, and to transfer the accumulated charge to the sample and readout circuit.

8. The active pixel sensor of claim 7, wherein:
each of the plurality of subpixels share a common via; and
the photodiode and transfer circuit is electrically connected to the sample and readout circuit by the common via.

9. The active pixel sensor of claim 8, further comprising:
a plurality of control switches, each of the plurality of control switches being between the common via and a corresponding sample and readout circuit on the lower substrate, and each of the plurality of control switches being configured to electrically disconnect the photodiode and transfer circuit from a corresponding sample and readout circuit during readout of the pixel data signal from the corresponding sample and readout circuit.

10. The active pixel sensor of claim 7, wherein the photodiode and transfer circuit is configured to transfer the accumulated charge directly to the sample and readout circuit without being stored on the upper substrate.

11. The active pixel sensor of claim 7, wherein the sample and readout circuit comprises:
a pixel capacitor configured to store the accumulated charge;
a sample and hold transistor coupled to the pixel capacitor, the sample and hold transistor being configured to readout the stored accumulated charge from the pixel capacitor in response to a sampling pulse; and
a readout circuit configured to output the pixel data signal corresponding to the accumulated charge in response to a select pulse.

12. The active pixel sensor of claim 11, wherein the readout circuit comprises:
a source-follower transistor configured to generate the pixel data signal based on the stored accumulated charge readout by the sample and hold transistor; and
a select transistor configured to output the pixel data signal in response to the select pulse.

13. An image sensor comprising:
an active pixel sensor including a plurality of unit pixels, each of the plurality of unit pixels including a plurality of subpixels, and each of the plurality of subpixels including,
a sample and readout circuit on a lower substrate, the sample and readout circuit being configured to store accumulated charge, and to output a pixel data signal corresponding to the stored accumulated charge, and
a photodiode and transfer circuit on an upper substrate, the upper substrate being stacked on the lower substrate, and the photodiode and transfer circuit being configured to accumulate charge in response to incident light, and to transfer the accumulated charge to the sample and readout circuit;
a line driver configured to control the active pixel sensor; and
an analog-to-digital converter configured to convert pixel data signals output from the active pixel sensor into digital image data.

14. The image sensor of claim 13, wherein:
each of the plurality of subpixels share a common via; and
the photodiode and transfer circuit is electrically connected to the sample and readout circuit by the common via.

15. The image sensor of claim 14, wherein the active pixel sensor further comprises:
a plurality of control switches, each of the plurality of control switches being between the common via and a corresponding sample and readout circuit on the lower substrate, and each of the plurality of control switches being configured to electrically disconnect the photodiode and transfer circuit from a corresponding sample and readout circuit during readout of the pixel data signal from the corresponding sample and readout circuit.

16. The image sensor of claim 13, wherein the photodiode and transfer circuit is configured to transfer the accumulated charge directly to the sample and readout circuit without being stored on the upper substrate.

17. The image sensor of claim 13, wherein the sample and readout circuit comprises:
a pixel capacitor configured to store the accumulated charge;
a sample and hold transistor coupled to the pixel capacitor, the sample and hold transistor being configured to readout the stored accumulated charge from the pixel capacitor in response to a sampling pulse; and
a readout circuit configured to output the pixel data signal corresponding to the accumulated charge in response to a select pulse.

18. The image sensor of claim 17, wherein the readout circuit comprises:
a source-follower transistor configured to generate the pixel data signal based on the stored accumulated charge readout by the sample and hold transistor; and
a select transistor configured to output the pixel data signal in response to the select pulse.

19.-20. (canceled)
